(19) United States
(12) Patent Application Publication
(10) Pub. No.: US 2024/0037635 A1
(43) Pub. Date: Feb. 1, 2024

(54) ITEM AGGREGATION WITH DATA CONVERSION

(71) Applicant: DoorDash, Inc., San Francisco, CA (US)

(72) Inventors: Grace Lu, Hudson, OH (US); Ben Damon, Los Angeles, CA (US); Martin Anet, Austin, TX (US); Trevor Beasty, New York, NY (US); Cameron Crowe Morgan, Rancho Santa Fe, CA (US); Prithvi Guruprasad, Fremont, CA (US); Hongwei Huang, San Francisco, CA (US); Kyle Hsiao, San Jose, CA (US); Rohit Raghunathan, Austin, TX (US); Victor Shao, Seattle, WA (US)

(21) Appl. No.: 18/360,204

(22) Filed: Jul. 27, 2023

Related U.S. Application Data
(60) Provisional application No. 63/393,607, filed on Jul. 29, 2022.

(51) Int. Cl. G06Q 30/0601; G06Q 10/0834

(52) U.S. Cl. CPC G06Q 30/0635; G06Q 10/0834; G06Q 30/0631; G06Q 30/0627

(57) ABSTRACT

A method includes receiving, by a central server computer, first item data in a first data format provided by first service providers and second item data in a second data format provided by second service providers. The method also includes converting the second item data in the second data format to the first data format. The central server computer can then receive a selection of a first service provider from a user device. The central server computer can then provide a display of first items provided by a first service provider and provide a display of second items provided by a second service provider. The method can then include receiving, by the central server computer from the user device, a selection of the displayed first items and the displayed second items. The method can then include initiating a fulfillment of the selection for first and second items.

### CROSS-REFERENCES TO RELATED APPLICATIONS

This application is a non-provisional application of and claims priority to U.S. Provisional Application No. 63/393,607, filed on Jul. 29, 2022, which is herein incorporated by reference in its entirety.

### SUMMARY

One embodiment of the invention includes a method. The method comprises: receiving, by a central server computer from a plurality of first service providers, first item data for a plurality of first items provided by the plurality of first service providers in a first data format; storing, by the central server computer in a data storage, the first item data for the plurality of first items provided by the plurality of first service providers in the first data format; receiving, by the central server computer from a plurality of second service providers, second item data for a plurality of second items provided by the second service providers in a second data format; converting, by the central server computer, the second item data for the plurality of second items in the second data format to the first data format; receiving, by the central server computer from a user device, a selection of a first service provider; providing, by the server computer to the user device, a display of one or more first items provided by the first service provider using first item data in the first data format; providing, by the server computer to the user device, a display of one or more second items provided by a second service provider using second item data in the first data format, along with the display of the one or more first items provided by the first service provider; receiving, by the server computer, a selection of the displayed one or more first items provided by the first service provider and the displayed one or more second items of the second service provider, wherein the one or more first items and the one or more second items form an aggregate of items; and initiating, by the central server computer, a fulfillment of the selection for the aggregate of items.

Another embodiment of the invention includes a central server computer. The central server computer comprises a processor; and a non-transitory computer readable medium comprising instructions, executable by the processor, for implementing operations including: receiving, by a central server computer from a plurality of first service providers, first item data for a plurality of first items provided by the plurality of first service providers in a first data format; storing, by the central server computer in a data storage, the first item data for the plurality of first items provided by the plurality of first service providers in the first data format; receiving, by the central server computer from a plurality of second service providers, second item data for a plurality of second items provided by the second service providers in a second data format; converting, by the central server computer, the second item data for the plurality of second items in the second data format to the first data format; receiving, by the central server computer from a user device, a selection of a first service provider; providing, by the server computer to the user device, a display of one or more first items provided by the first service provider using first item data in the first data format; providing, by the server computer to the user device, a display of one or more second items provided by a second service provider using second item data in the first data format, along with the display of the one or more first items provided by the first service provider; receiving, by the server computer, a selection of the displayed one or more first items provided by the first service provider and the displayed one or more second items of the second service provider, wherein the one or more first items and the one or more second items form an aggregate of items; and initiating, by the central server computer, a fulfillment of the selection for the aggregate of items.

Yet another embodiment of the invention includes a method. The method comprises: transmitting, by a user device to a central server computer, a selection of a first service provider; receiving, by user device from the central server computer, a display of one or more first items provided by the first service provider using first item data in the first data format; receiving, by the user device from the central server computer, a display of one or more second items provided by a second service provider using second item data in the first data format, along with the display of the one or more first items provided by the first service provider, wherein the central server computer generates the second item data in the first data format by converting second item data in a second data format to the first data format; and transmitting, by user device to the server computer, a selection of the displayed one or more first items provided by the first service provider and the displayed one or more second items of the second service provider, wherein the one or more first items and the one or more second items form an aggregate of items, and wherein the central server computer initiates a fulfillment of the selection for the aggregate of items.

A better understanding of the nature and advantages of embodiments of the invention may be gained with reference to the following detailed description and accompanying drawings.

### BRIEF DESCRIPTION OF THE DRAWINGS

FIG. 1 shows a system according to embodiments.

FIG. 2 shows a second data format and a first data format according to embodiments.

FIG. 3 shows a flowchart for generating a display of first items and second items according to embodiments.

FIG. 4 shows a location based pairing method according to embodiments.

FIG. 5 shows a user device with a user interface showing a display of first items and second items.

FIG. 6 shows a flowchart for a method according to embodiments.

FIG. 7 shows a block diagram of a user device according to embodiments.

FIG. 8 shows a block diagram of a central server computer according to embodiments.

FIG. 9 shows exemplary screenshots according to embodiments.

### DETAILED DESCRIPTION

Delivery systems can use transporters to deliver items from various service providers to end users. However, if an end user wants one type of item from one service provider and another type of item from another service provider, then the user may need to submit two orders to the delivery system. This can result in two transporters making two trips to two different service providers to obtain the different items for the end user. This is inefficient and cumbersome.

In some embodiments, an end user can use the delivery system to request different items from different service providers (e.g., different restaurants) in a single order. In this case, one transporter may go to the different service providers to retrieve the different items and deliver them to the end user in one transaction.

Problems arise, however, in presenting the different items from different service providers to an end user so that the end user can select from them. For example, a first service provider, which is a restaurant, may offer prepared food items for sale, while a second service provider, which is a liquor store, may offer alcohol items for sale. The item data (e.g., physical descriptions, prices, etc.) of the food items that is used by the restaurant is different than the description data of the alcohol items from the liquor store. This can be because the items at the liquor store are retail items, while the prepared food items are not retail items. The heterogeneous nature of the different item data provided by different types of service providers makes it difficult to integrate the different items into a single management system (e.g., for common data processing purposes). It also makes it difficult to present the different items from different types of service providers to end users for delivery.

Embodiments address these and other problems. In embodiments, item data for different items from different types of service providers can be displayed in a seamless manner on user device of an end user. The presentation of the different items can appear is if they are on the same menu or catalogue, even though the different items are coming from different service providers.

Prior to discussing embodiments, some terms can be described in further detail.

A “user” may include an individual or a computational device. In some embodiments, a user may be associated with one or more personal accounts and/or mobile devices. In some embodiments, the user may be a cardholder, account holder, or consumer.

A “user device” may be any suitable electronic device that can process and communicate information to other electronic devices. The user device may include a processor and a computer-readable medium coupled to the processor, the computer-readable medium comprising code, executable by the processor. The user device may also each include an external communication interface for communicating with each other and other entities. Examples of user devices may include a mobile device (e.g., a mobile phone), a laptop or desktop computer, a wearable device (e.g., smartwatch), etc.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, a partially completed state, or a final state. After the fulfillment request is in a final state, it can be accepted by the central server computer, and the central server computer can send a fulfillment request confirmation to the end user device.

A “transporter” can be an entity that transports something. A transporter can be a person that transports a resource using a transportation device (e.g., a car). In other embodiments, a transporter can be a transportation device that may or may not be operated by a human. Examples of transportation devices include cars, boats, scooters, bicycles, drones, airplanes, etc. A transporter may also use a user device (e.g., a driver using a mobile phone) or a user device be in coupled to the transporter (e.g., a telecommunications unit in an autonomous vehicle).

A “server computer” is typically a powerful computer or cluster of computers. For example, the server computer can be a large mainframe, a minicomputer cluster, or a group of servers functioning as a unit. In one example, the server computer may be a database server coupled to a Web server. A server computer can also include a cloud computer.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

The term “artificial intelligence model” or “machine learning model” can include a model that may be used to predict outcomes to achieve a pre-defined goal. A machine learning model may be developed using a learning algorithm, in which training data is classified based on known or inferred patterns.

“Machine learning” can include an artificial intelligence process in which software applications may be trained to make accurate predictions through learning. The predictions can be generated by applying input data to a predictive model formed from performing statistical analyses on aggregated data. A model can be trained using training data, such that the model may be used to make accurate predictions.

An “item” can include an object such as edible consumable goods such as food, meal, beverages, candy, desserts, appetizers, snacks, etc. Editable consumer goods can include foods that are prepared on demand vs. pre-packaged goods. The latter can often be categorized as retail items or retail goods. Items can also include other types of goods such as hardware supplies, office supplies, toiletries, flowers, cosmetics, media such as books, electronics, etc.

Some embodiments include a method comprising receiving, by a central server computer, first item data in a first data format provided by first service providers and second item data in a second data format provided by second service providers. The method also includes converting the second item data in the second data format to the first data format. The first item data and the second item data in the first format can be stored in database.

At some point in time, the central server computer can then receive a selection of a first service provider from an end user operating a user device. The central server computer can then provide a display of first items (e.g., pizza, pasta, etc.) provided by a first service provider and can also provide a display of second items (e.g., beer, wine, soft drinks) provided by a second service provider. The method can then include receiving, by the central server computer from the user device, a selection of the displayed first items and the displayed second items. The method can then include initiating a fulfillment of the selection for first and second items. The fulfillment is completed by a transporter that delivers the first and second items (e.g., pizza and wine) to the end user.

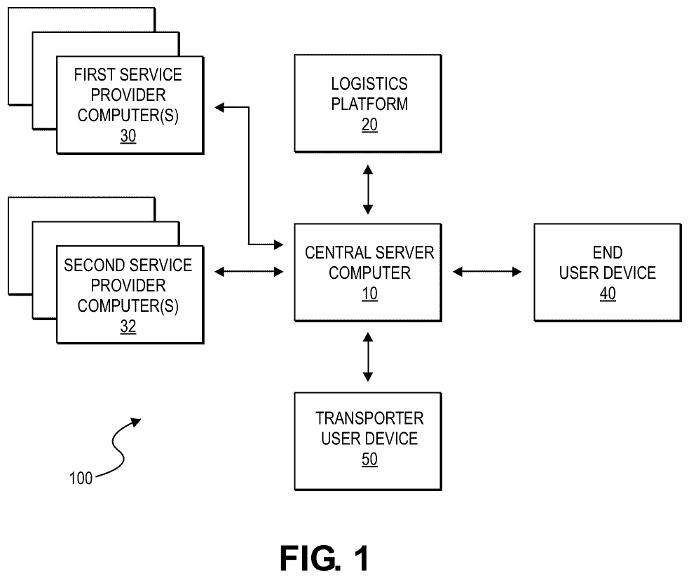

FIG. 1 shows a system according to embodiments. The system includes a central server computer 10 in communication with an end user device 40 and one or more transporter user devices 50. The central server computer 10 may also be in communication with a logistics platform 20. One or more service provider computers including two or more first service provider computers 30 and two or more second service provider computers 32 may be in communication with the central server computer 10.

The logistics platform 20 can include a location determination system, which can determine the location of various user devices such as transporter user devices (e.g., transporter user device 50) and end user devices (e.g., end user device 40). The logistics platform 20 can also include routing logic to efficiently route transporters using the transport user devices to various service providers that have the resources that are to be delivered to the end users. The logistics platform 20 can be part of the central server computer 10 or can be system that is separate from the central server computer 10.

The first service provider computers 30 can communicate with the central server computer 10 via one or more APIs and may be operated by first service providers. First service providers may initially present resources such as goods and/or services to end users via an application on the end user device 40. In some embodiments, a first service provider is a service provider that has a resource that the end user wants to obtain. In some embodiments, an end user can interact with an interaction application on an end user device to purchase a resource from the first service provider, before any resources from any second service providers are presented to the end user on the interaction application. A first service provider can choose to allow resources from second service providers to be displayed along with resources provided by the first service provider. In some examples, the first service provider can select a pairing subset of the plurality of second service providers that can be paired with the first service provider (e.g., allow pairing with liquor stores and restaurants, but may not allow pairing with hardware stores), or may select a pairing of item categories (e.g., allow pairing of alcohol items with pizza). This pairing information can be stored at the central server computer 10.

In some embodiments, descriptions of resources provided by the first service providers can be in a first data format. The first data format can include some data fields that can hold a set of data values which can be chosen by end users so that they can modify a particular resource. For example, a data field in the first format can allow a restaurant such as a pizza parlor can to enter different values (e.g., order elements and their prices) corresponding to a base pizza and specific toppings for the pizza. The data in the data field can correspond to items from which the user can select to create a desired pizza. For instance, the data field may have values of $1 for pepperoni, $1.50 for sausage, $10 for a base cheese pizza, etc. While pizza is used as an example, ability to allow a user to select options to customize a desired resource can apply to other food items or non-food items (e.g., electronics). The first data format can also include static data fields such as those that may contain static data such as a description of an item.

The second service provider computers 32 may communicate with the central server computer 10 via one or more APIs and may be operated by second service providers that can offer resources such as items (e.g., goods) to end users like the first service providers. However, some second service providers can provide data for its resources in a second data format, instead of the first data format. In some embodiments, the resources provided by the second service providers can be retail items and the data associated with those items is in a second data format, which is different than the first data format. In the case of retail items, the data regarding those retail items (e.g., the price, weight, size, name, price, etc.) is mostly fixed and is not customizable like a pizza. Further, retail items often have more data associated with them relative to items such as food items from a restaurant. For example, a bottle of wine can have item data such as a size, weight, name, a stock keeping unit (e.g., SKU) and price associated with it. A data element such as a SKU would be relevant data for a bottle of wine, but would not be relevant for a prepared food item such as a pizza.

The communication networks that allow the entities in FIG. 1 to communicate may include any suitable communication medium. The communication network may be one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Message between the entities, providers, networks, and devices illustrated in FIG. 1 may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

The first service provider computers 30 and the second service provider computers 32 can store item data relating to the plurality of resources that they provide. The first service provider computers 30 can store item data for first items in a first data format and can also transmit the data to the central server computer 10 for processing and/or storage. The second service provider computers 32 can store item data for second items in a second data format and can also transmit the item data to the central server computer 10 for processing and/or storage.

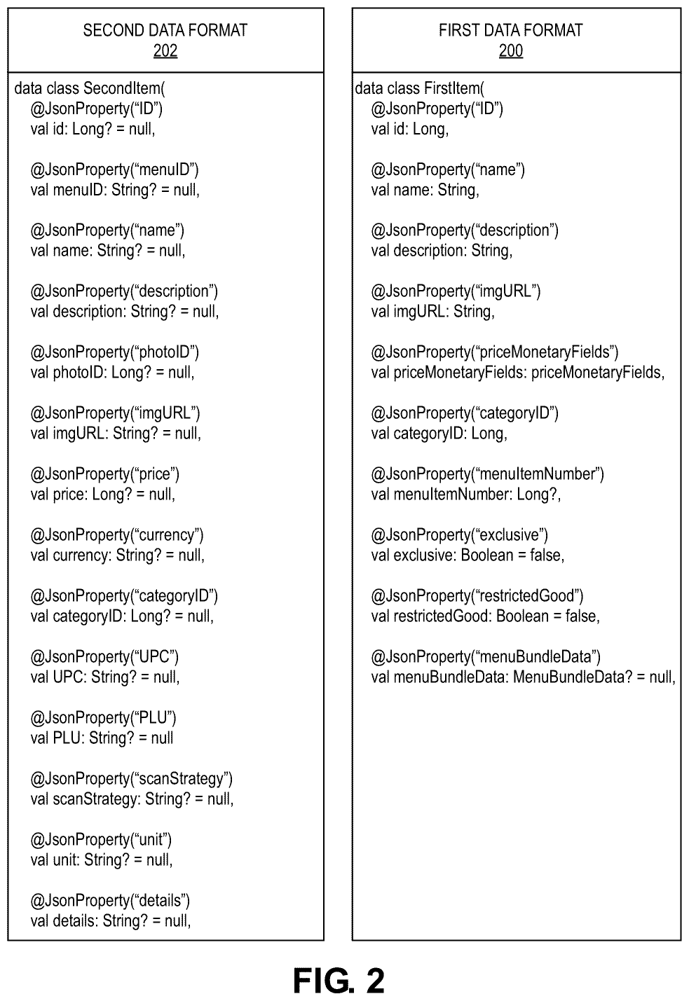

FIG. 2 shows an exemplary second data format 202 and an exemplary first data format 200 according to embodiments. The second data format 202 shows exemplary data fields associated with a second item offered by a second service provider. Many, most, or all of the data fields in the second data format can contain data values that are fixed and not selectable by an end user. The first data format 200 shows exemplary data fields associated with a first item offered by a first service provider. Some of the data fields in the first data format can contain fixed values that are not selectable by an end user, while other data fields can contain values that can be selected by an end user to customize a desired first item. In this example, there are more data fields in the first data format 200 than the second data format 202. This can be because the first data format may be used by a restaurant which offers prepared food items for sale, while the second data format may be used by retailers that offer retail items for sale. As noted above, retail items may have more data associated with them than prepared food items.

First service providers can store and provide first item data in the first data format 200 for a plurality of first items to a central server computer. Similarly, second service providers can store and provide second item data in the second data format 202 for a plurality of second items to the central server computer. The central server computer can convert the second item data in the second data format 202 to the first data format 200, so that the second items can be presented to end users along with first items. The display of the first item and the second items can appear seamless to the end user and can appear as if the second items are being sold by the first service provider instead of the second service provider. The end user then has the option to select combinations of first and second items in a single transaction, and the combinations of first and second items can be delivered to the end user by a transporter.

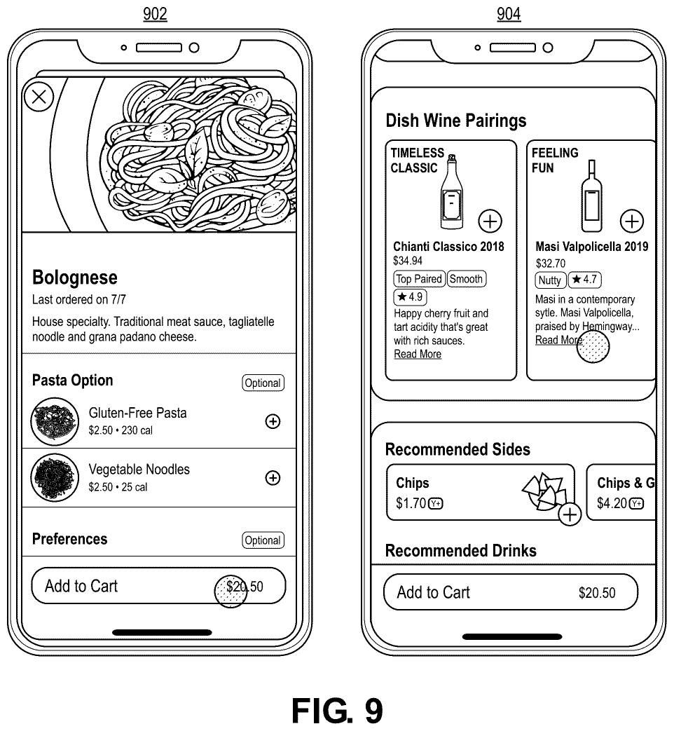

An illustration of this is in FIG. 9, which shows a first user interface 902 displaying a first item being ordered from a first service provider such as an Italian restaurant. This particular Italian restaurant may not have a liquor license and may not sell alcoholic beverages. The second user interface 904 can show bottles of wine that may pair well with the first item shown in the first user interface 902. The wine may be sold be a second service provider that only sells alcoholic beverages. However, the end user can select both the first item shown in the first user interface 902 and a bottle of wine from the second user interface 904 and purchase them in a single transaction such that they are delivered to the end user. Note that the interface can appear seamless to the end user, since the item data for the first item from the first service provider and item data from the second service provider are in the same data format.

The second data format 202 can have a second number of data fields and the first data format 200 can have a first number of data fields. In some embodiments, second item data in the second data format 202 and first item data in the first data format 200 can be stored in a different partition of a data storage at the central server computer. Although specific data fields are shown in FIG. 2, the second data format 202 and the first data format 200 can include more or less data fields than are shown in FIG. 2.

The second data format 202 may include: an identifier of the item (“ID” can be a variable that acts as a unique identifier (e.g., “XS1234”) that is assigned to the item by a central server computer); a menu identifier of the item (“menuID” can store the position of the item in a catalogue or menu for a particular service provider, such as the third item on a menu); a name of the item (“name” can be the manufacturer's given name of the item, such as “ABC White Wine”); a description of the item (“description” can store a text description of the item); a photo identifier of the item (e.g., “photoID” can be a variable that stores the location in memory, such as in a particular database, of a photo of the item); an image of the item (“imgURL” can store an image of the item or store a URL address of the image of the item); a value of the item (“price” can store the price of an item); a currency of the value of the item (“currency” can store the type of currency that the price is in); a category identifier of the item (“categoryID” can identify a category, such as food, clothing, furniture, etc., of the item); a UPC (Universal Product Number) of the item (“UPC” can store the UPC of the item); a PLU code (Price Look-Up code) of the item (“PLU” can store the PLU code of the item); a scan strategy to check out the item (“ScanStrategy” can be a description of an efficient manner to scan the PLU code of the item); a unit size of the item (“unit” can identify the number of units of an item, such as six cans of beer in a six-pack of beer); details of the item (“details” can store supplementary information about the item), etc. The second data format can have more or less than these example data fields in other embodiments.

The first data format 200 can include at least some of the data fields of the second data format 202. For example, the first data format 200 can include an item (“identifier of the item (“ID”), a name name”), a description of the item (“description”), an image of the item (“imgURL”), and a category identifier of the item (“categoryID”). The first data format 200 can additionally include a data field that contains specific data values associated with selectable items that can be used to customize a particular item (“PriceMonetaryFields”). For example, a pizza may be a base item, and may have a base cost of $10, and may have additional modifiers such as extra cheese which add an additional cost of $1, or extra pepperoni which may cost an extra $2. The values or $10, $1, and $2 would be populated in the data field “PriceMonetaryFields” and may be selectable by an end user to customize a particular item. The first data format 200 can also include a menu item number (“menultemNumber” can identify the item in a catalogue or menu provided by the second service provider), an exclusivity identifier of the item (“exclusive” can indicate that the item is exclusive to the organization operating the central server computer), a restricted goods identifier (“restrictedGood” can determine if the item is a restricted good, such as alcohol), and menu pairing data (“menuBundleData” can determine any restrictions on the pairing of the item with another item).

Data for an item (e.g., a can of beer) in the second data format 202 can be converted into the first data format 200. The conversion of data from the second data format 202 to the first data format 200 can include keeping some data fields and the data values therein, deleting some data fields and the data values contained therein, or populating new data fields that are in the first data format 200, but are not in the second data format.

Illustratively, the data values in the data fields of the second data format 202 can be inserted into the corresponding data fields in the first data format 200. For example, the “name” data field in the second data format may be populated with the name of a type of beer. That name is then transferred or kept in a corresponding “name” data field in the first data format. In another example, another part of the conversion may be to populate new data fields that are in the first data format 200, but are not in the second data format with specific data values. For example, if the item sold by a second service provider is a can of beer and the data describing that can of beer is in the second data format 202, then the data field “priceMonetaryFields” in the first data format 200 needs to be populated for the can of beer. A can of beer cannot be modified by an end user like a food item such as a pizza. Thus, any modifiers in the data field “priceMonetaryFields” may have a value of “0” or “null” for the can of beer to indicate that it cannot be modified. This data field might only contain the base price for the can of beer and nothing else. As another part of the conversion of data from the second data format 202 to the first data format 200, some data values for a product in the second data format 202 may be omitted in the first data format 200. This is because the data fields in the second data format 202 are not in the first data format 200. For example, the “UPC” data field is in the second data format 202, but not the first data format 200. Therefore, the UPC value for the can of beer would not carry over to the first data format 200.

In embodiments, the central server computer 10 can receive first item data in the first data format 200 for a plurality of first items from a plurality of first service providers and receive second item data in the second data format 202 for a plurality of second items from a plurality of second service providers. The central server computer 10 can store the first item data and the second item data in separate databases, or it can convert the second item data from the second data format 202 into the first data format 200 to store both the first item data and the second item data in a single database. In some examples, the central server computer 10 can convert second item data from the second data format 202 into the first data format 200 directly after receiving the second item data from a second service provider.

A fulfillment request can begin with a user of the end user device 40 of FIG. 1 accessing an application installed on the end user device 40 to view the different service providers and the items that they are offering for sale. By converting the second item data as described above, the data for items offered by first and second service providers can be processed and/or manipulated so that the items are presented together to an end user on the application in a seamless manner. The end user can select any combination of the first and second items in a single transaction, so that they can be delivered to the end user by a single transporter.

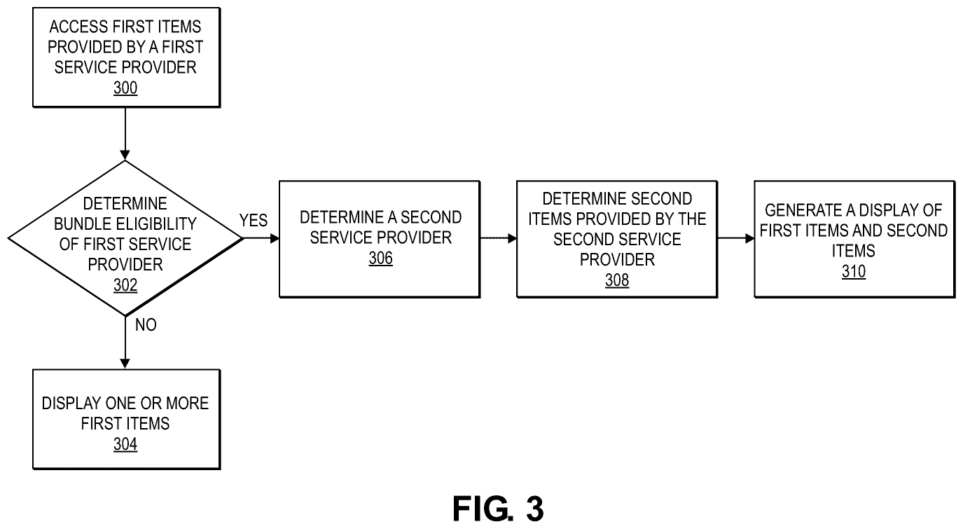

FIG. 3 shows a flowchart for generating a display of first items and second items according to embodiments. The steps of FIG. 3 can be performed by the central server computer in response to an end user selecting a first service provider and optionally one or more first items on the application installed on the end user device 40.

At step 300, the central server computer 10 can access the catalogue of first items provided by the first service provider selected by the end user. For example, the central server computer 10 can access a database to retrieve item data of the first items provided by the first service provider. The item data can be in the first data format 200 of the FIG. 2.

At step 302, the central server computer 10 can determine the bundle eligibility of the first service provider selected. For example, the central server computer 10 can determine if the first service provider allows for second items from second service providers to be displayed along with their catalogue of first items.

At step 304, if the selected first service provider does not allow displaying of second items from second service providers, the central server computer 10 can generate a display of one or more first items. For example, the central server computer 10 can display the first items retrieved from the database using the item data.

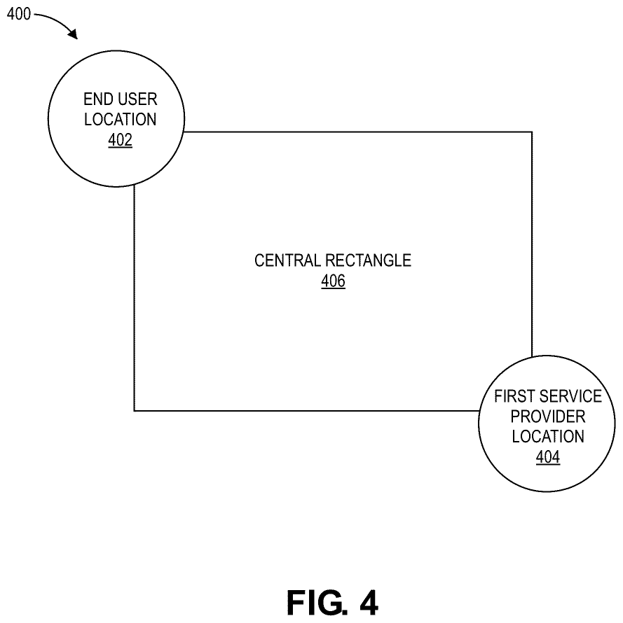

At step 306, if the selected first service provider allows for the display of second items from a plurality of second service providers along with first items provided by the first service provider, the central server computer 10 can determine a second service provider from among the plurality of second service providers. In some embodiments, the central server computer 10 can determine the second service provider based upon the selected first service provider. For example, the central server computer 10 can train and use a machine learning model to determine second service providers that are complimentary to the selected first service provider and optionally the selected one or more first items (e.g., the machine learning model can determine that ice cream is commonly purchased with hamburgers). In other embodiments, the central server computer 10 can determine the second service provider based upon trends of a plurality of end users. For example, the central server computer 10 can select a second service provider that has high ratings from a plurality of end users or is commonly selected by the plurality of end users. In yet other embodiments, the central server computer 10 can determine the second service provider using a location based pairing method. Location based pairing methods can include using the distance between the first service provider and a second service provider or the end user (e.g., a second service provider that is near the route from the first service provider to the end user's location). A specific example of location based pairing is described below with reference to FIG. 4. In yet other embodiments, the central server computer 10 can determine the second service provider based upon the second items provided by the second service provider. For example, the central server computer 10 can determine a second service provider that has the largest catalogue of second items.

At step 308, after determining a second service provider, the central server computer 10 can determine second items provided by the second service provider. The central server computer 10 can access a database that stores item data for the plurality of second items provided by the second service provider. In some embodiments, after accessing the database storing item data for the plurality of second items, the central server computer 10 can convert the item data of the plurality of second items from the second data format into the first data format (e.g., as described above with respect to FIG. 2). In some embodiments, the central server computer 10 can determine a subset of the plurality of second items provided by the second service provider. For example, the central server computer 10 can choose a subset of the most purchased second items (e.g., most purchased by the end user previously or by a plurality of end users having similar characteristics as the end user) from the plurality of second items provided by the second service provider. In another example, if the end user selected one or more first items, the central server computer 10 can determine a subset of the plurality of second items based on the one or more first items selected by the end user (e.g., if the end user selected to buy a paintbrush from a hardware store, the central server computer 10 can determine that paint from a specialty store is suitable).

At step 310, after determining second items provided by the second service provider, the central server computer 10 can generate a display of first items and second items using the first item data in the first format and the second item data in the first format. The central server computer 10 can generate a display the first items provided by the selected first service provider along with the second items provided by the second service provider. The display can then be provided to the end user via the application installed on the end user device 40. In some embodiments, the display of first items and second items can be used to modify an existing display of first items. The subset of the plurality of second items can be highlighted within the display of the one or more second items provided by the second service provider.

FIG. 4 shows a location based pairing method according to embodiments. The location based pairing method can be one method used by the central server computer 10 to determine a second service provider at step 306. The central server computer 10 can generate an eligibility map 400 using an end user location 402 and a first service provider location 404. The eligibility map 400 can include a first circle with a short radius (e.g., 0.5 mile, 1 mile, 1.5 mile, 3 mile, etc.) centered around the end user location 402 and a second circle with a similar short radius centered around the first service provider location 404. A central rectangle 406 can then be generated by using the latitude and longitude of both the end user location 402 and the first service provider location 404 (e.g., end user location 402 longitude<x<first service provider location 404 longitude and end user location 402 latitude<y<first service provider location 404 latitude). Second service providers located within the central rectangle 406 can be candidates chosen by the central server computer for pairing with the first service provider.

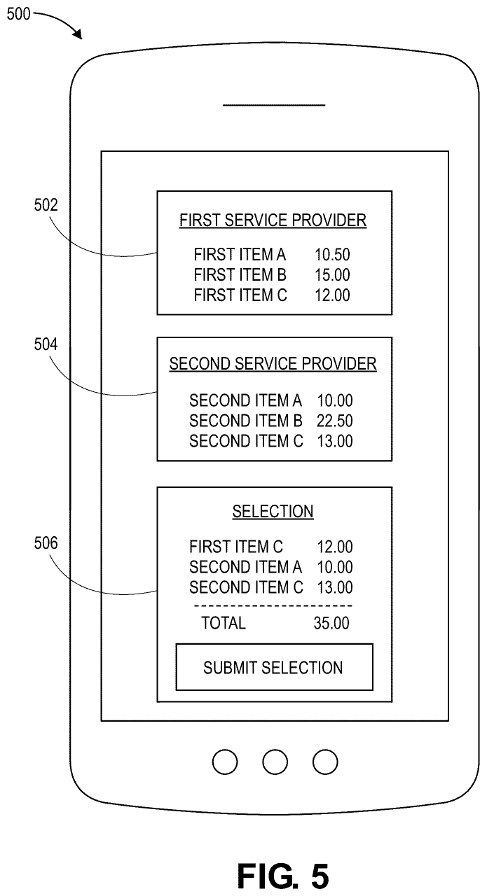

FIG. 5 shows an end user device 500 with a user interface showing a display of first items and second items. The application installed on the end user device 500 can receive the display of first items and second items generated by the central server computer 10. The end user device 500 shows a display including a plurality of first items provided by a first service provider 502 and a plurality of second items provided by a second service provider 504. In some embodiments, the end user device 500 may initially display the plurality of first items provided by a first service provider 502. The end user may then select one or more of the first items, and the central server computer 10 can generate the display of first items and second items in response to the selection. In some embodiments, the initial display can then be modified to include the plurality of second items provided by a second service provider 504. The end user can select one or more first items from the plurality of first items provided by the first service provider 502. The end user can then select one or more second items from the plurality of second items provided by a second service provider 504. The end user device 500 can display the selection 506 of the end user containing an aggregate of items formed by the selection of one or more first items provided by the first service provider and one or more second items provided by the second service provider. The end user may then press a submit selection button to transmit the aggregate of items to the central server computer 10, and initiate the fulfillment of the aggregate of items.

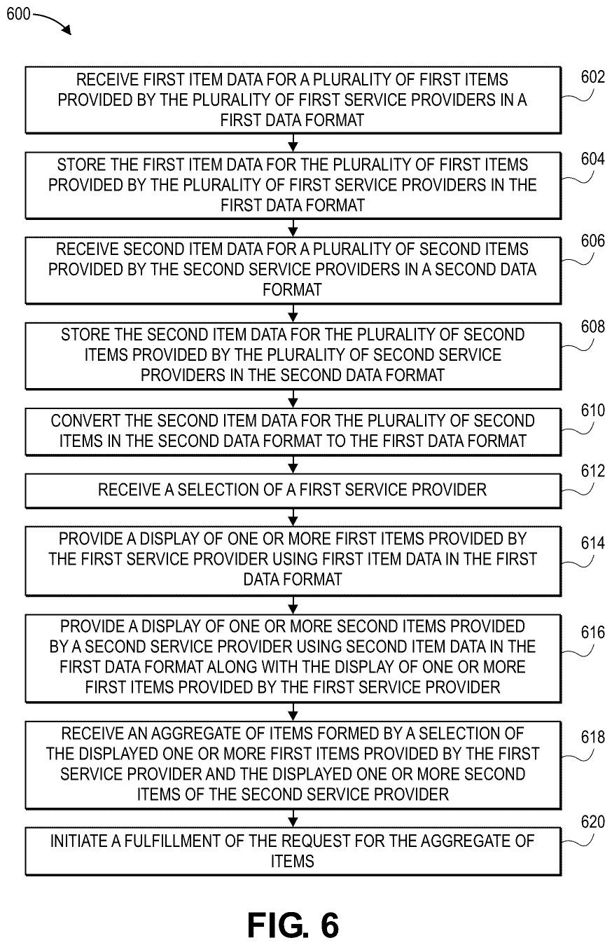

FIG. 6 shows a flowchart for a method 600 according to embodiments. The method 600 can be performed by the central server computer 10, first service provider computers second service provider computers 32, and the end user device 40 of FIG. 1 to initiate a fulfillment request of an aggregate of items.

At step 602, the central server computer 10 can receive first item data for a plurality of first items provided by the plurality of first service providers in a first data format from a plurality of first service providers. The first items provided by the first service providers can be modifiable items, such as restaurant items or some electronics, which can be modified by an end user before the end user purchases the first item. In addition, each of the plurality of first service provider can choose to allow resources from second service providers to be displayed along with resources provided by the first service provider. In some examples, the first service provider can choose to allow pairing with a subset of a plurality of second service providers (e.g., allow pairing with hardware stores and restaurants, but not grocery stores), or may choose to allow pairing of specific item categories (e.g., allow pairing with food, but not clothing).

At step 604, after receiving the first item data for the plurality of first items provided by the first service providers in the first data format, the central server computer 10 can store, in a data storage, the first item data for the plurality of first items provided by the plurality of first service providers computers 30 in the first data format. The first data format can have a first number of data fields. For example, the central server computer 10 can store first item data including each of the data fields shown by the example first data format 200 of FIG. 2.

At step 606, the central server computer 10 can receive second item data for a plurality of second items provided by the second service providers in a second data format from the plurality of second service provider computers 32. The second items provided by the second service providers can be fixed items, such as retail items (e.g., hardware items, grocery items, clothing, etc.).

At step 608, after receiving the second item data for the plurality of second items provided by the second service providers in the second data format, the central server computer 10 can store, in the data storage, the second item data for the plurality of second items provided by the plurality of second service providers in the second data format. The second data format can have a second number of data fields. For example, the central server computer 10 can store second item data including each of the data fields shown by the second data format 202 of FIG. 2. In some embodiments, the central server computer 10 can store the second item data in the second data format in a different data storage partition than the first item data in the first data format is stored in.

At step 610, after storing the second item data for the plurality of second items provided by the plurality of second service providers, the central server computer 10 can convert the second item data for the plurality of second items in the second data format to the first data format. The conversion of data from the second data format to the first data format can include keeping some data fields and the data values therein, deleting some data fields and the data values contained therein, and/or populating new data fields that are in the first data format 200, but are not in the second data format.

At step 612, after converting the second item data from the second data format to the first data format, the central server computer 10 can receive a selection of a first service provider from the end user device 40. In some embodiments, the central server computer 10 can additionally receive a selection of one or more first items provided by the first service provider from the end user device 40.

At step 614, after receiving the selection of the first service provider, the central server computer 10 can provide a display of one or more first items provided by the first service provider using first item data in the first data format to the end user device 40. In some embodiments, the central server computer 10 can provide the display of one or more first items to the end user device 40 prior to the end user making a selection of one or more of the first items. In some embodiments, the central server computer 10 can determine a second service provider based on the selection of one or more of the first items. In examples, the central server computer 10 can determine the second service provider based upon the selected first service provider (e.g., using a machine learning model or pattern analysis), based upon trends of a plurality of end users (e.g., highly rated second service providers or highly purchased from), based upon the distance between the first service provider and a the second service provider or the end user (e.g., location based such as in FIG. 4), based upon the second items provided by the second service provider (e.g., second service providers with a high variety), or otherwise.

At step 616, the central server computer 10 can provide a display of one or more second items provided by a second service provider using second item data in the first data format, along with the display of the one or more first items provided by the first service provider to the end user device 40. In some embodiments, the central server computer 10 can determine a subset of the plurality of second items provided by the second service provider by selecting a subset of the most purchased second items (e.g., most purchased by the end user previously or by a plurality of end users similar to the end user), based on the one or more first items selected by the end user, or otherwise. The subset of the plurality of second items can be highlighted within the display of the one or more second items provided by the second service provider. The display of first items and second items can displayed on the end user device 40 as shown in FIG. 5.

At step 618, after providing the display of first items and second items, the central server computer 10 can receive a selection of the displayed one or more first items provided by the first service provider and the displayed one or more second items of the second service provider from the end user device 40. The one or more first items and the one or more second items can form an aggregate of items that are to be purchased.

At step 620, after receiving the selection of the displayed one or more first items and second items, the central server computer 10 can initiate a fulfillment of the selection for the aggregate of items. The fulfillment can include submitting a payment transaction for a total that includes the cost of all items selected by the end user. The fulfillment can also include providing a notification to various transporters in the vicinity of the service providers associated with the first and/or second items being purchased by the end user, and then receiving an acceptance from a transporter to delivery the purchased items to the end user. The central server computer 10 can also monitory the delivery of the selected first and second items to the end user to ensure that they are delivered to the end user in a timely manner.

If the first item(s) and/or second item(s) contain restricted item(s) such as alcohol, the transporter may perform a verification check (e.g., checking an identification) to ensure that the end user is able to receive the restricted item(s). Proof of the verification may include taking a picture or the user's identification (e.g., a driver's license) with the transporter's user device and transmitting it to the central server computer for verification.

At the end of the transaction, the machine learning model described above can be updated. The data for the recently competed transaction including the selection of items by the end user, the time of delivery, etc. can be used as training data for the machine learning model to improve its prediction capabilities.

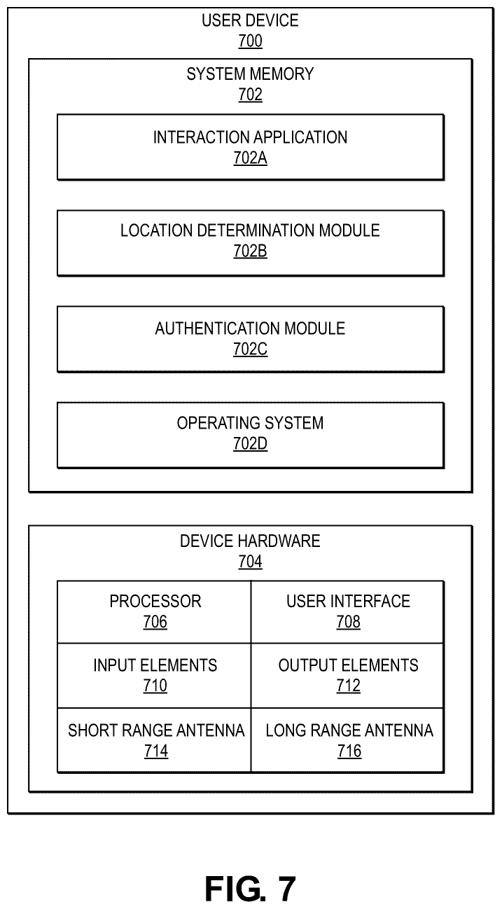

FIG. 7 shows a block diagram of a user device 700 according to embodiments. The user device 700 may include device hardware 704 coupled to a system memory 702.

Device hardware 704 may include a processor 706, a short range antenna 714, a long range antenna 716, input elements 710, a user interface 708, and output elements 712 (which may be part of the user interface 708). Examples of input elements may include microphones, keypads, touchscreens, sensors, etc. Examples of output elements may include speakers, display screens, and tactile devices. The processor 706 can be implemented as one or more integrated circuits (e.g., one or more single core or multicore microprocessors and/or microcontrollers) and is used to control the operation of mobile communication device 7. The processor 706 can execute a variety of programs in response to program code or computer-readable code stored in the system memory 702 and can maintain multiple concurrently executing programs or processes.

The long range antenna 716 may include one or more RF transceivers and/or connectors that can be used by the user device 700 to communicate with other devices and/or to connect with external networks. The user interface 708 can include any combination of input and output elements to allow a user to interact with and invoke the functionalities of the user device 700. The short range antenna 709 may be configured to communicate with external entities through a short range communication medium (e.g. using Bluetooth, Wi-Fi, infrared, NFC, etc.). The long range antenna 719 may be configured to communicate with a remote base station and a remote cellular or data network, over the air.

The system memory 702 can be implemented using any combination of any number of non-volatile memories (e.g., flash memory) and volatile memories (e.g. DRAM, SRAM), or any other non-transitory storage medium, or a combination thereof media. The system memory 702 may store computer code, executable by the processor 705, for performing any of the functions described herein.

The system memory 702 may also store an interaction application 702A, a location determination module 702B, an authentication module 702C, and an operating system 702D. The interaction application 702A may be a resource delivery application such as a food delivery or item delivery application. The location determination module 302B can be used to determine a location of the user device 700. The authentication module 702C may comprise code, executable by the processor 706, to authenticate a user. This can be performed using user secrets (e.g., passwords) or user biometrics.

The system memory 702 may also comprise a computer readable medium comprising, code executable by the processor 706 to perform operations including: transmitting, to a central server computer, a selection of a first service provider; receiving, by user device from the central server computer, a display of one or more first items provided by the first service provider using first item data in the first data format; receiving, by the user device from the central server computer, a display of one or more second items provided by a second service provider using second item data in the first data format, along with the display of the one or more first items provided by the first service provider, wherein the central server computer generates the second item data in the first data format by converting second item data in a second data format to the first data format; and transmitting, by user device to the server computer, a selection of the displayed one or more first items provided by the first service provider and the displayed one or more second items of the second service provider, wherein the one or more first items and the one or more second items form an aggregate of items, and wherein the central server computer initiates a fulfillment of the selection for the aggregate of items.

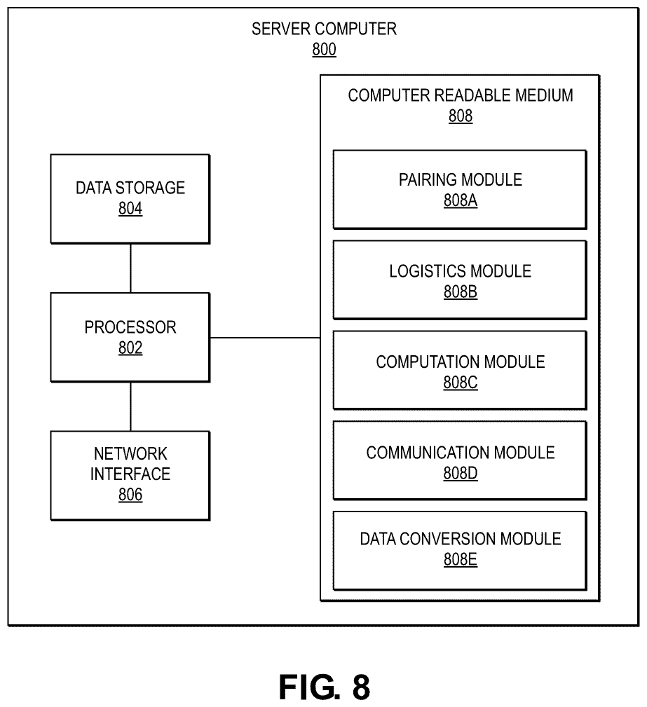

FIG. 8 shows a block diagram of a central server computer 800 according to embodiments. The central server computer 800 may comprise a processor 802, which may be coupled to a memory 804, a network interface 806, and a computer readable medium 808. The memory 804 can store first item data in a first data format, second item data in a second data format or in the first data format.

The computer readable medium 808 store computer code, executable by the processor 802, for performing a method including: receiving, by a central server computer from a plurality of first service providers, first item data for a plurality of first items provided by the plurality of first service providers in a first data format; storing, by the central server computer in a data storage, the first item data for the plurality of first items provided by the plurality of first service providers in the first data format; receiving, by the central server computer from a plurality of second service providers, second item data for a plurality of second items provided by the second service providers in a second data format; converting, by the central server computer, the second item data for the plurality of second items in the second data format to the first data format; receiving, by the central server computer from a user device, a selection of a first service provider; providing, by the server computer to the user device, a display of one or more first items provided by the first service provider using first item data in the first data format; providing, by the server computer to the user device, a display of one or more second items provided by a second service provider using second item data in the first data format, along with the display of the one or more first items provided by the first service provider; receiving, by the server computer, a selection of the displayed one or more first items provided by the first service provider and the displayed one or more second items of the second service provider, wherein the one or more first items and the one or more second items form an aggregate of items; and initiating, by the central server computer, a fulfillment of the selection for the aggregate of items.

The computer readable medium 808 may also comprise several software modules including a pairing module 808A, a logistics module 808B, a computation module 808C, and a communication module 808D. The pairing module 808A can be used to determine a second service provider based upon a first service provider and/or a selection of one or more first items from the first service provider. The logistics module 808B can be used to manage the fulfillment request for the aggregate of items. The computation module 808C can be used to manage machine learning models, generate location-based pairings, and work in conjunction with the logistics module 808B to facilitate fulfillment requests. The communication module 808D can be used to communicate with external computers and devices. The data conversion module 808E can comprise code for converting data from one data format to another data format (e.g., from a second data format to a first data format as described above).

Embodiments provide for several advantages. Embodiments allow service providers with items having data in specific data formats to be presented with items from other service providers in other data formats. As such, items from different service providers can be conveniently and quickly presented to an end user and obtained by the end user in a single transaction. After an end user selects to view an item catalogue of a first service provider, a central server computer can use various methods, such as machine learning model based, history based, item based, or location-based recommendations to provide recommendations for end users to purchase second items from a second service provider. The recommendations provided by embodiments are seamless, such that end users are not met with any extra burden when purchasing an aggregate of items from a first and second service provider.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

In the description above, some methods are described with steps in a specific order for purposes of clarity. It is understood that the methods can change the order of steps, while still being within embodiments of the invention.

In the description above, labels such as “first” and “second” are used to differentiate certain elements (e.g., a first service provider and a second service provider). These terms are not intended to specific any particular order, and any specific set number of elements. For example, there can be third, fourth, etc. service providers in embodiments.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a central server computer from a plurality of first service providers, first item data for a plurality of first items provided by the plurality of first service providers in a first data format;
storing, by the central server computer in a data storage, the first item data for the plurality of first items provided by the plurality of first service providers in the first data format;
receiving, by the central server computer from a plurality of second service providers, second item data for a plurality of second items provided by the second service providers in a second data format;
converting, by the central server computer, the second item data for the plurality of second items in the second data format to the first data format;
receiving, by the central server computer from a user device, a selection of a first service provider;
providing, by the central server computer to the user device, a display of one or more first items provided by the first service provider using first item data in the first data format;
providing, by the central server computer to the user device, a display of one or more second items provided by a second service provider using second item data in the first data format, along with the display of the one or more first items provided by the first service provider;
receiving, by the central server computer from the user device, a selection of the displayed one or more first items provided by the first service provider and the displayed one or more second items of the second service provider, wherein the one or more first items and the one or more second items form an aggregate of items; and
initiating, by the central server computer, a fulfillment of the selection for the aggregate of items.

2. The method of claim 1, wherein converting the second item data for the plurality of second items in the second data format to the first data format comprises transferring some data values in data fields in the second data format to similar data fields in the first data format, not including data fields and the values in the data fields in the second data format in the first data format; and populating data fields in the first data format that are not present in the second data format.

3. The method of claim 1, further comprising:
determining, by the central server computer, the second service provider based on a proximity of the second service provider to the first service provider.

4. The method of claim 3, wherein determining the second service provider from the plurality of second service providers based on the first service provider comprises using a location based pairing method.

5. The method of claim 3, wherein determining the second service provider from the plurality of second service providers based on the first service provider comprises using a machine learning model.

6. The method of claim 1, further comprising:
receiving, by the central server computer, pairing data associated with the first service provider, the pairing data indicating allowable second service providers and allowable items that can be displayed alongside first items from the first service provider on an application on the user device.

7. The method of claim 1, wherein the first data format has data fields including: a name, description, image, category identifier, and value field.

8. The method of claim 1, wherein the second data format has data fields including: a name, description, image, category identifier, value, currency, and a universal product code.

9. The method of claim 1, wherein the display of one or more first items provided by the first service provider and the display of one or more second items provided by the second service provider are displayed on an application installed on the user device.

10. The method of claim 1, wherein the selection of the first service provider causes the central server computer to select the second service provider of the plurality of second service providers.

11. The method of claim 1, wherein the selection of one or more first items provided by the first service provider is used to determine the second service provider from the plurality of second service providers.

12. The method of claim 1, wherein the selection of one or more first items provided by the first service provider is used to determine a subset of second items provided by the second service provider.

13. The method of claim 1, wherein the first items are prepared food items and the second items are alcoholic beverages.

14. The method of claim 1, wherein the fulfillment of the selection for the aggregate of items is completed by a single transporter that obtains the first items from the first service provider and the second items from the second service provider and delivers the aggregate of items to the user.

15. A central server computer comprising:
a processor; and
a non-transitory computer readable medium comprising instructions, executable by the processor, for implementing operations including:
receiving, from a plurality of first service providers, first item data for a plurality of first items provided by the plurality of first service providers in a first data format;
storing, in a data storage, the first item data for the plurality of first items provided by the plurality of first service providers in the first data format;
receiving, by the central server computer from a plurality of second service providers, second item data for a plurality of second items provided by the second service providers in a second data format;
converting the second item data for the plurality of second items in the second data format to the first data format;
receiving, from a user device, a selection of a first service provider;
providing, to the user device, a display of one or more first items provided by the first service provider using first item data in the first data format;
providing, to the user device, a display of one or more second items provided by a second service provider using second item data in the first data format, along with the display of the one or more first items provided by the first service provider;
receiving, by the user device, a selection of the displayed one or more first items provided by the first service provider and the displayed one or more second items of the second service provider, wherein the one or more first items and the one or more second items form an aggregate of items; and
initiating, a fulfillment of the selection for the aggregate of items.

16. A method comprising:
transmitting, by a user device to a central server computer, a selection of a first service provider;
receiving, by user device from the central server computer, a display of one or more first items provided by the first service provider using first item data in a first data format;
receiving, by the user device from the central server computer, a display of one or more second items provided by a second service provider using second item data in the first data format, along with the display of the one or more first items provided by the first service provider, wherein the central server computer generates the second item data in the first data format by converting second item data in a second data format to the first data format; and
transmitting, by the user device to the central server computer, a selection of the displayed one or more first items provided by the first service provider and the displayed one or more second items of the second service provider, wherein the one or more first items and the one or more second items form an aggregate of items, and wherein the central server computer initiates a fulfillment of the selection for the aggregate of items.

17. The method of claim 16, wherein the user device is a mobile phone.

18. The method of claim 16, wherein the first items are food items, and the second items are retail items.

19. The method of claim 16, wherein converting comprises populating new data fields and removing data fields.

20. The method of claim 19, wherein converting further comprises keeping data fields in the first and second data formats.
